(19) United States
(12) Patent Application Publication
(10) Pub. No.: US 2023/0125304 A1
(43) Pub. Date: Apr. 27, 2023

(54) PNEUMATIC VEHICLE TIRE WITH NOISE ABSORBER, AND METHOD FOR DETECTING A PNEUMATIC VEHICLE TIRE WITH NOISE ABSORBER AND FOR RECYCLING A PNEUMATIC VEHICLE TIRE WITH NOISE ABSORBER

(71) Applicant: Continental Reifen Deutschland GmbH, Hannover (DE)

(72) Inventors: Mikheil Doroshenko, Garbsen (DE); Andreas Tyburski, Ilsede (DE)

(73) Assignee: Continental Reifen Deutschland GmbH, Hannover (DE)

(21) Appl. No.: 17/760,439

(22) PCT Filed: Nov. 30, 2020
(86) PCT No.: PCT/EP2020/083929

§ 371 Date: Aug. 9, 2022

(30) Foreign Application Priority Data
Feb. 10, 2020 (DE) 10 2020 201 585.6

(51) Int. Cl. B60C 19/00; B29B 17/02

(52) U.S. Cl. CPC B60C 19/002; B29B 17/02; B29B 2017/0279; B29L 2030/00

(57) ABSTRACT

The invention relates to a pneumatic vehicle tire with at least one sound absorber adhesively attached in its interior to the inner surface opposite the tread. The invention further relates to a process for detecting a pneumatic vehicle tire with a sound absorber and to a process for recycling a pneumatic vehicle tire with a sound absorber.

According to the invention the radially inward-facing surface of the sound absorber has at least one luminescent agent applied to it.

The tire according to the invention is detected via the luminescent agent.

The invention relates to a pneumatic vehicle tire with at least one sound absorber adhesively attached in its interior to the inner surface opposite the tread. The invention further relates to a process for detecting a pneumatic vehicle tire with a sound absorber and to a process for recycling a pneumatic vehicle tire with a sound absorber.

It is known to provide pneumatic vehicle tires with sound absorbers to reduce driving sound. The sound absorber is typically in the form of a foam ring which reduces the vibration of air in the tire and thus leads to an improvement in the sound behavior in the vehicle. The foam ring may be made of open-celled foam and is also referred to as an “interior absorber”.

The sound absorber is, for example, a polyurethane foam ring and is therefore made of different materials to the other tire components.

However, it is also possible to attach a plurality of sound absorbers as disclosed in DE 102017210929 A1 or EP 1 510 366 A1.

Recycling of pneumatic vehicle tires with sound absorbers encounters the problem that prior to the customary comminution of the tires a material separation is desirable, i.e. the sound absorber should be separated in particular.

However depending on the optical state of the sound absorber—this may have a dark color and/or be dirty—and the light conditions, detection of pneumatic vehicle tires with sound absorbers may be impeded. This in turn impedes the distinguishing and separation of pneumatic vehicle tires with and without sound absorbers, which in turn impedes or retards recycling of the pneumatic vehicle tires against the backdrop of the desired material separation.

It is accordingly an object of the present invention to provide a pneumatic vehicle tire with at least one sound absorber adhesively attached in its interior to the inner surface opposite the tread, wherein the sound absorber has a radially inward-facing surface (pneumatic vehicle tire with sound absorber) which is easier to identify as a pneumatic vehicle tire with a sound absorber and is therefore easier to distinguish from pneumatic vehicle tires without sound absorbers.

The object is achieved when the radially inward-facing surface of the sound absorber has at least one luminescent agent applied to it.

As a result of the pneumatic vehicle tires with sound absorbers comprising at least one luminescent agent on the radially inward-facing surface of the sound absorber, the tires are easier to distinguish from pneumatic vehicle tires without sound absorbers.

In particular detection may be carried out in an automated process with a detector, in particular a photodiode, without any need for individual inspection of the tire by an operator.

However, any operator can also identify such a tire with a sound absorber more quickly and unambiguously as a result of the luminescent agent.

This significantly simplifies and facilitates the recycling of tires with (and without) sound absorbers.

The operations of detection using a detector and identification by an operator are both referred to as “detection” in the context of the present invention.

Since only the surface of the sound absorber is provided with a luminescent agent, the tires may be distinguished from one another without any need to make the whole sound absorber luminescent.

The invention is more particularly elucidated hereinbelow and further advantageous embodiments are described. Unless otherwise stated or technically infeasible, different embodiments may also be combined with one another.

A “luminescent agent” is to be understood as meaning a substance/an agent which has luminescent properties. Such substances are also known as “fluorophores”. According to Römpp Online Chemie Lexikon (last updated August 2008) “luminescence . . . is the emission of light in the visible, UV and IR spectral range of gases, liquids and solids after supply of energy”.

Depending on the type of energy supplied, a distinction can be made, for example, between photoluminescence, chemiluminescence, thermoluminescence and radioluminescence.

Types of luminescence that are caused in particular by photoluminescence include fluorescence and phosphorescence, wherein a distinction is made according to the duration between excitation (absorption of light) and luminescence (glowing through emission).

In the context of the present invention, the “luminescent agent” should not be restricted from the outset by a (formal) distinction between the different types of luminescence with regard to the type of excitation or the duration of the emission.

In advantageous embodiments of the invention, it is preferable when the luminescent agent is excitable by light and may therefore be described as a photoluminescent agent. It is further preferable when the luminescent agent has fluorescent or phosphorescent properties and is therefore a fluorescent agent or a phosphorescent agent.

In advantageous embodiments of the invention, it is preferable when the luminescent agent absorbs light in the wavelength range from 200 to 700 nm and emits light in the range from 350 to 800 nm. It may therefore be excited with UV light or visible light and may emit light in a range which is visible to humans and/or may be measured and thus detected using a photodiode.

The luminescent agent may in principle be any substance exhibiting luminescent properties and is therefore selected for example from the group comprising coumarin derivatives such as methoxycoumarin, peptides or proteins, such as green fluorescent protein (GFP), rhodamine, organic substances available under the trade names Alexa Fluor®, for example Alexa Fluor® 350, Alexa Fluor® 405, Alexa Fluor® 488, Alexa Fluor® 532, etc., quantum dots, for example QDOT® 525, QDOT® 565, QDOT® 665.

It is especially possible to employ all of the agents disclosed in the following sources:

https://docs.abcam.com/pdf/immunology/fluorochrome guide.pdf
https://www.biosyn.com/Images/ArticleImages/Comprehensive %20f luorophore%20list.pdf
https://en.wikipedia.org/wiki/Fluorophore
https://en.wikipedia.org/wiki/Ethidium bromide

In the event that the luminescent agent is a molecule, the weight average molecular weight (Mw) is for example and in particular from 200 to 250 000 g/mol.

In the event that the luminescent agent is quantum dots, the particle size (measured by dynamic light scattering) is for example from 2 to 2000 nm.

It is an essential feature of the invention that the sound absorber contains at least one luminescent agent on its radially inward-facing surface. In this case, two or more different agents may also be present. “At least one” refers to the type of luminescent agent. All elucidations apply both to the presence of one type of luminescent agent or two or more types of luminescent agents unless expressly stated otherwise.

Even the smallest amounts can have the desired luminescent effect.

The term “radially inward-facing surface” is to be understood as meaning a position which is not the surface with which the sound absorber adheres to the tire inner surface but rather is especially arranged on the sound absorber in the direction of the tire interior, facing away from the tread in the radial direction.

In the case of individual blocks of two or more sound absorbers this is to be understood as every surface oriented inward and not adherent to the tire inner surface.

It is not necessary for the entire radially inward-facing surface to be covered with the luminescent agent.

The coverage of even a relatively small proportion of the surface can have the desired luminescent effect.

In advantageous embodiments of the invention the luminescent agent covers 0.01% to 100%, preferably 0.01% to 90%, particularly preferably 1% to 80%, for example 1% to 10%, of the radially inward-facing surface of the sound absorber.

In advantageous embodiments the luminescent agent is arranged circumferentially in the form of one or more strip(s), wherein the strip or strips may be continuous or interrupted. One or more strip(s) may be easily circumferentially applied in an automated manner continuously or in sections.

Two or more strips are arranged in parallel or not in parallel with one another, for example.

In advantageous embodiments the luminescent agent has been arranged on the surface of the sound absorber in individual spatial (i.e. separate) regions. The regions may be distributed systematically or randomly.

Even the smallest amounts in regions that are small relative to the surface and have a diameter of less than 1 mm can bring about the technical advantage that the tires can be detected and thus more easily distinguished from tires without a sound absorber and luminescent agent.

In a further advantageous embodiment of the invention the luminescent agent covers 90% to 100%, for example 100%, of the radially inward-facing surface of the sound absorber.

It may optionally be helpful for the tire and/or the excitation source and optionally the detector to be rotated during detection.

Various embodiments of how the luminescent agent may be applied to the sound absorber surface are described below. All embodiments are combinable with the described possible configurations and the resulting coverage of the surface of the sound absorber.

In advantageous embodiments of the invention the luminescent agent has been applied to the surface of the sound absorber by means of a dispersion, in particular suspension or emulsion, wherein the dispersion contains from 1% to 80% by weight, preferably from 5% to 50% by weight, particularly preferably from 10% to 30% by weight, very particularly preferably 20% to 30% by weight, of luminescent agents.

The reported amounts in % by weight relate to the total mass of the dispersion before drying.

In advantageous embodiments the dispersion contains at least one binder, such as polystyrene or polymethyl methacrylate or styrene-acrylate copolymer or polyvinyl acetate.

The dispersion is preferably a suspension. In this embodiment the luminescent agent(s) are suspended in a liquid.

The reported amounts in % by weight relate to the total mass of the suspension before drying.

A suspension may be applied easily and in a material-saving manner.

The liquid of the suspension may be any conceivable liquid compatible with the particular sound absorber. In advantageous embodiments of the invention the suspension is an aqueous suspension which is particularly environmentally friendly.

In further advantageous embodiments of the invention the luminescent agent has been applied to the surface of the sound absorber by means of a solution, wherein the solution contains at least one solvent and from 1% to 80% by weight, preferably from 5% to 50% by weight, particularly preferably from 10% to 30% by weight, very particularly preferably 20% to 30% by weight, of luminescent agents.

In this embodiment the luminescent agents are dissolved in a liquid.

The reported amounts in % by weight relate to the total mass of the solution before drying.

In advantageous embodiments the solution too contains at least one binder, such as polystyrene or polymethyl methacrylate or styrene-acrylate copolymer or polyvinyl acetate.

A solution is simple to apply.

The solvent(s) may be any conceivable liquid compatible with the particular sound absorber.

In advantageous embodiments of the invention the solution is an aqueous suspension which is particularly environmentally friendly and non-flammable.

In advantageous embodiments the luminescent agent is water-soluble.

In advantageous embodiments it is preferable for the liquid of the solution or dispersion, in particular suspension or emulsion, to comprise water which in particular has the abovementioned advantages.

In advantageous embodiments the luminescent agent is hydrophilic and dissolved in water or hydrophobic and dispersed in water or partially dissolved in water.

In further preferred embodiments of the invention the solvent is at least one organic solvent. The organic solvent may in principle be any suitable solvent known to those skilled in the art, such as alcohols (mono- or polyalcohols), ketones, esters, aldehydes, aromatics, alkanes such as hexane, or ethers, such as petroleum ether.

In preferred embodiments the organic solvent is selected from solvents which are compatible with the sound absorber and the remaining tire components and do not cause these to swell or dissolve constituents thereof, such as in particular simple alcohols, such as ethanol or isopropanol. These are also relatively environmentally friendly and most water-insoluble luminescent agents are easily soluble in them.

In further advantageous embodiments of the invention the luminescent agent has been applied in the form of a solid, in particular in powder form.

The powder may have been applied by air atomization, for example using a gun, or applied electrostatically.

Depending on the type of sound absorber it may be advantageous to apply an adhesion-promoting layer before application of the solid.

In further advantageous embodiments of the invention the luminescent agent is attached to the radially inward-facing surface of the sound absorber as a constituent of a film. A film too is able to be applied easily and in a material-saving manner, in particular at a constant film thickness.

In advantageous embodiments the luminescent agent has been applied at a film thickness (measured in the radial direction (rR) perpendicular to the axial direction (aR) of the vehicle tire) of 100 nm (nanometers) to 3500 μm (micrometers).

In advantageous embodiments of the invention the film thickness is 1 to 400 μm (micrometers), particularly preferably 5 μm to 100 μm.

In further advantageous embodiments of the invention the film thickness is 2500 to 3500 μm (micrometers). In this embodiment, strips (stickers) having dimensions of 100 mm×10 mm×3 mm can be used for example.

The described film thicknesses and embodiments allow the sound absorber to receive a luminescent marking in the most material saving manner possible.

In advantageous embodiments of the invention the sound absorber is black or almost black. This means that the sound absorber has a hue according to RAL color codes 9004 to 9007, 9011 or 9017 to 9023 for example.

The sound absorber may also be brown or gray.

The sound absorber of the pneumatic vehicle tire according to the invention may in principle be any element or any combination of elements which in a pneumatic vehicle tire may be attached to the inner surface thereof by adhesion and which reduces/reduce the sound emissions of the tire in vehicle operation.

In a preferred embodiment the at least one sound absorber is at least one porous damping element. Porous materials especially have the advantage that in addition to sound absorption they also introduce into the tire an intrinsic weight that is not excessive and the rolling resistance properties of the tire are therefore not unnecessarily impaired.

The porous material from which the damping element is formed is for example selected from the group containing polyurethane, in particular polyether-based and/or polyester-based polyurethane foams having a density of 18 to 300 kg/m³, preferably 30 to 35 kg/m³, and a hardness of 6.5 kilopascals, polyesters having a density of 18 to 300 kg/m³ preferably 30 to 35 kg/m³, and a hardness of 6.5 kilopascals, polyethers, and also any porous, sound-absorbing material mixtures, for example glass or rock wool, loop-pile or deep-pile fabric or nonwovens or cork. Further possible porous materials which are suitable for utilization as a damping element are for example a melamine resin foam or a builder's foam.

It is particularly preferable when the sound absorber, preferably at least one porous damping element, contains at least one polyurethane. Polyurethane is particularly suitable on account of its specific density and further nature and also its availability.

In a particularly advantageous embodiment the porous damping element is a sound-absorbing foam ring closed or open in the circumferential direction. Said ring ensures even sound absorption and the tire maintains its uniformity. The ring may be closed in the circumferential direction or be open in the form of a strip, wherein the ends of the strip may or may not be in contact or may also overlap.

The foam of the foam ring is preferably an open-celled foam since said foam is best suited for absorbing sound.

It is particularly preferable when the sound absorber is a closed sound-absorbing foam ring made of polyurethane, particularly preferably a polyether-based polyurethane foam.

Such foams are known to those skilled in the art.

The sound absorber(s) may moreover have any desired shape, for example individual elements in the shape of blocks, strips or the like, which may be combined with one another as desired.

The sound absorber or sound absorbers are preferably adhesively attached to the tire inner surface using an adhesive. Exemplary adhesives and combinations of adhesives include: an adhesive tape and/or a silicone-based adhesive and/or a two-component adhesive and/or a construction adhesive and/or a polyurethane adhesive and/or a rubber-based adhesive and/or a tire repair adhesive and/or an instant adhesive and/or an adhesive based on cyanoacrylate and/or based on a water-based acrylic system having a polyethylene terephthalate structure and/or based on acrylonitrile-butadiene rubber in conjunction with a formaldehyde resin dissolved in acetone and/or based on a silane polyether and/or based on a polybutene crosslinked with butyl rubber and/or based on an alkoxysilicone.

Such adhesives especially have the advantage that they can be applied in an amount sufficiently small to ensure that they have cured after bonding. This ensures that they are not tacky after removal of the sound absorber and before comminution during recycling of the tires, thus allowing the tires without the sound absorber to be comminuted in the known manner.

The sound absorber is applied to the inner surface of the tire using processes and apparatuses known to those skilled in the art.

The luminescent agent is applied to the radially inward-facing surface of the sound absorber according to its type. It may in particular be applied as a suspension, emulsion or solution.

The invention further provides a process for detecting a pneumatic vehicle tire according to the invention to distinguish pneumatic vehicle tires comprising a sound absorber from pneumatic vehicle tires without a sound absorber.

In the process according to the invention the sound absorber is detected by an operator or using a detector as a result of the luminescent agent.

The detector may in particular be a photodiode.

Suitable detectors are known to those skilled in the art and are usually computer-aided.

The detector may further be a handheld device or a detector used in an automated process by a robot.

The invention further provides a process for recycling pneumatic vehicle tires according to the invention comprising at least the process steps of:

A) providing the pneumatic vehicle tire to be recycled;
B) performing the process according to the invention for detecting a pneumatic vehicle tire according to the invention as a result of the luminescence;
C) separating the sound absorber from the pneumatic vehicle tire;
D) subsequently comminuting the pneumatic vehicle tire without the sound absorber.

In advantageous embodiments the process steps A) to D) are carried out in an automated manner.

The invention further provides a process for recycling pneumatic vehicle tires comprising at least the process steps of:

a) providing pneumatic vehicle tires to be recycled;
b) performing the process according to the invention for detecting a pneumatic vehicle tire according to the invention in order to distinguish pneumatic vehicle tires with a sound absorber from pneumatic vehicle tires without a sound absorber;
c) spatially separating pneumatic vehicle tires comprising a sound absorber from pneumatic vehicle tires without a sound absorber;
d) recycling pneumatic vehicle tires without sound absorbers comprising comminution of the pneumatic vehicle tires;
e) transferring pneumatic vehicle tires comprising a sound absorber to a separate recycling process comprising separation of the sound absorber and comminution of the pneumatic vehicle tires only subsequently.

In advantageous embodiments the process steps a) to e) are carried out in an automated manner. In an advantageous embodiment of the invention step c) is carried out in an automated manner in conjunction with step b).

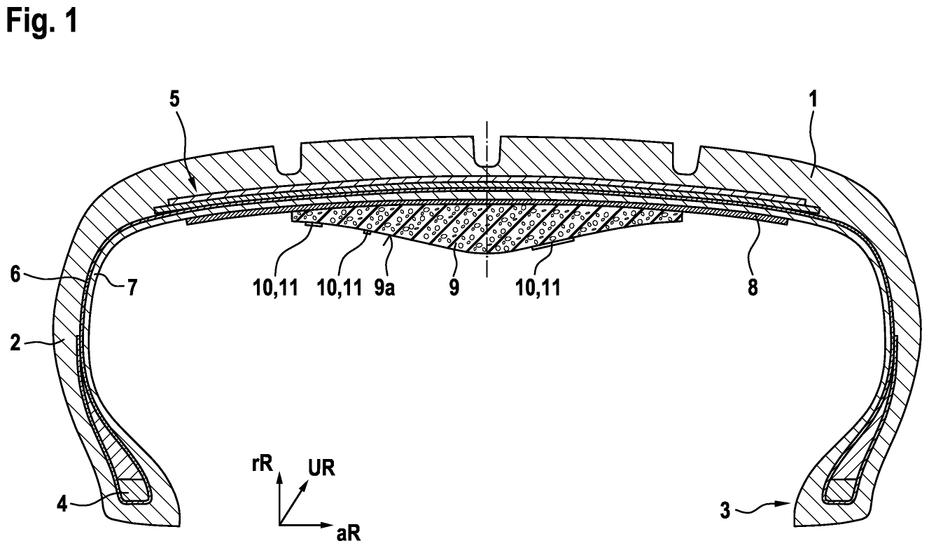

Further particulars of the invention are more particularly elucidated with reference to FIG. 1, which is a schematic representation of an exemplary embodiment.

The invention shall be more particularly elucidated hereinbelow with reference to exemplary embodiments. An example of a pneumatic vehicle tire according to the invention is shown in FIG. 1 in the context of a schematic representation.

FIG. 1 depicts a cross section through a radial passenger motor vehicle tire having a profiled tread 1, sidewalls 2, bead regions 3, bead cores 4 and also a multi-ply belt bandage 5 and a carcass insert 6. On its inner surface, the tire is covered with an inner layer 7 of an airtight rubber compound. On the inner surface of the inner layer 7 opposite the tread strip 1 a sound-absorbing foam ring as sound absorber 9 is subsequently (in the finished tire) adhesively attached using an adhesive 8, for example a polyurethane-based adhesive 8.

With respect to its sound-absorbing properties the sound-absorbing foam ring is matched to the tire cavity frequency. The sound absorber 9 in the form of a foam ring here has for example approximately an elongated triangle cross section that is symmetrical with respect to the tire equator.

The foam of the foam ring is an open-celled foam since said foam is particularly well suited for absorbing sound. The foam comprises polyurethane for example.

The sound absorber 9 has a radially inward-facing surface 9a.

According to the example in FIG. 1 the radially inward-facing surface 9a of the sound absorber 9 has at least one luminescent agent 10 applied to it.

The luminescent agent 10 is applied, for example, in a solution or suspension. The liquid of the solution or suspension is, for example, water, wherein styrene-acrylate copolymer is further present as a binder.

The luminescent agent 10 may be any of the abovementioned agents which is soluble or suspensible in water, such as Rhodamine 6G for example.

The sound absorber 9 is thus luminescent on the inward-facing surface 9a. The liquid of the suspension is, for example, water, wherein styrene-acrylate copolymer may further be present as a binder.

The luminescent agent 10 covers, for example, 5% of the surface 9a of the sound absorber 9.

In FIG. 1 the luminescent agent 10 has been applied with a random distribution in individual spatial regions 11, as illustrated again in plan view in FIG. 1a. FIG. 1a shows a schematic sector of the plan view of the radially inward-facing surface 9a.

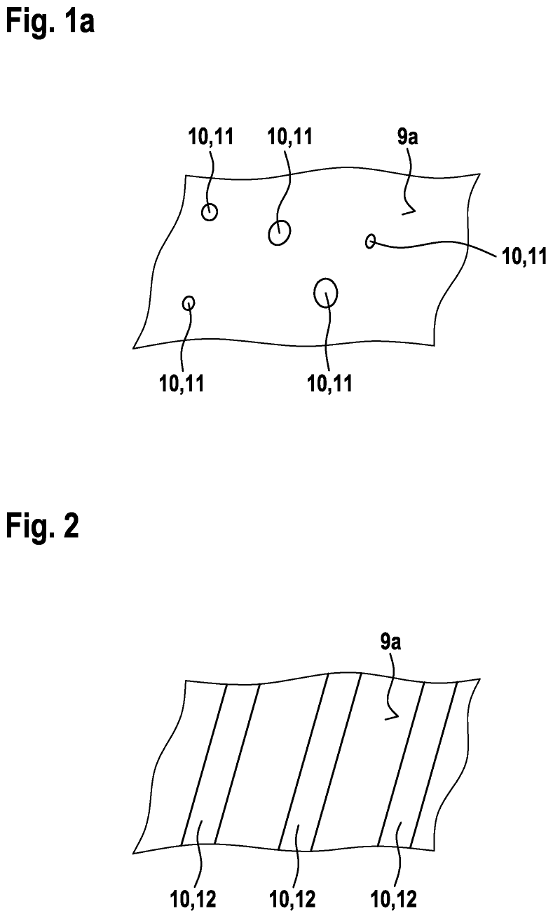

FIG. 2 likewise shows a schematic sector of the plan view of the radially inward-facing surface 9a. In FIG. 2, the luminescence agent 10 has been applied in the form of a plurality of parallel strips 12. There may be three (see FIG. 2) or four strips (not shown in the figures) for example.

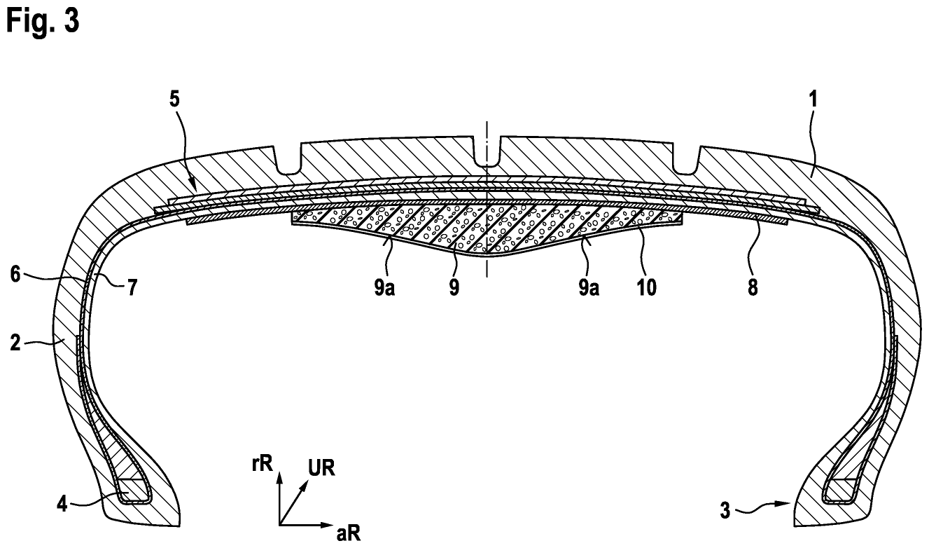

In FIG. 3 the luminescent agent 10 covers almost the entire surface 9a.

After excitation, in particular by light in the wavelength range from 200 to 700 nm, the luminescence through emission of light in the wavelength range from 350 to 800 nm may either be identified by an operator or detected using a photodiode.

The pneumatic vehicle tire described by way of example can now be distinguished, using a photodiode, from pneumatic vehicle tires without a sound absorber by the process according to the invention as a result of the luminescence.

This allows pneumatic vehicle tires with sound absorbers according to the invention and pneumatic vehicle tires without sound absorbers to be distinguished from one another in a, for example automated, process according to the invention, spatially separated and supplied to different recycling processes. In the case of a tire according to the invention sound absorbers comprising luminescent agent are initially removed from the tire in an additional step.

### LIST OF REFERENCE NUMERALS

### (Part of the Description)

1 Tread
2 Sidewall
3 Bead region
4 Bead core
5 Belt bandage
6 Carcass insert
7 Inner layer
8 Adhesive
9 Sound absorber
9a Radially inward-facing surface of the sound absorber
10 Luminescent agent
11 Individual spatial regions
12 Strips
rR radial direction
aR axial direction
UR circumferential direction of the tire

1.-12. (canceled)

13. A pneumatic vehicle tire comprising:
a tread, sidewalls and an inner layer opposite the tread;
a sound absorber attached to the inner layer, in the form of a foam ring having an elongated triangle cross section, matched to a tire cavity frequency and having a radially inward facing surface; and
a luminescent agent applied to radially inward facing surface of the sound absorber.

14. The tire of claim 13, the luminescent agent is a fluorescent agent or phosphorescent agent.

15. The tire of claim 13, the luminescent agent absorbs light in the wavelength range from 200 to 700 nm and emits light in the wavelength range from 350 to 800 nm.

16. The tire of claim 15, the luminescent agent being dispersion applied by a solution that contains from 1% to 80% by weight of luminescent agents.

17. The tire of claim 13, the luminescent agent covers 0.01% to 100% of the radially inward facing surface of the sound absorber.

18. The tire of claim 13, the luminescent agent comprises a film attached to the radially inward facing surface.

19. The tire of claim 18, the sound absorber comprising a porous damping element.

20. The tire of claim 19, the foam ring being closed.

21. The tire of claim 13, the sound absorber comprises polyurethane.

22. The tire of claim 13, the luminescent agent applied with a random distribution in spatial regions of the radially inward facing surface.

23. The tire of claim 13, the luminescent agent applied as a plurality of parallel strips.

24. The tire of claim 13, the luminescent agent being a film having a film thickness in a radial direction (rR) perpendicular to an axial direction (aR) of the tire of 100 nm (nanometers) to 3500 μm (micrometers).

25. The tire of claim 13, the luminescent agent is hydrophilic or hydrophobic.

26. A method of recycling a tire, the method comprising:
providing a tire to be recycled, the tire comprising a sound absorber attached to an inner layer, in the form of a foam ring having an elongated triangle cross section, matched to a tire cavity frequency and having a radially inward facing surface;
determining presence of a luminescent agent on the radially inward facing surface of the sound absorber;
removing the sound absorber based on the determined presence of the luminescent agent; and
recycling the tire based after removing the sound absorber.

27. The method of claim 26, determining the presence of the luminescent agent comprises using a photo-diode.
